(19) United States
(12) Patent Application Publication
(10) Pub. No.: US 2026/0095813 A1
(43) Pub. Date: Apr. 2, 2026

(54) COMMUNICATION DEVICE AND CONTROL METHOD

(71) Applicant: CANON KABUSHIKI KAISHA, Tokyo (JP)

(72) Inventor: YUKI YOSHIKAWA, Kanagawa (JP)

(21) Appl. No.: 19/409,379

(22) Filed: Dec. 4, 2025

Related U.S. Application Data
(63) Continuation of application No. PCT/JP2024/019969, filed on May 31, 2024.

(30) Foreign Application Priority Data
Jun. 6, 2023 (JP) 2023-093354

(51) Int. Cl. H04W 28/20; H04W 48/16

(52) U.S. Cl. CPC H04W 28/20; H04W 48/16

(57) ABSTRACT

A communication device functioning as an access point provides, to a user, a setting screen usable for designating an operation setting of an operating channel of an access point device in a specific frequency band. The setting screen is controlled such that a channel different from a channel recommended for scanning via the setting screen is prevented from being selected as the operation setting of the operating channel of the access point in the specific frequency band.

### CROSS-REFERENCE TO RELATED APPLICATIONS

This application is a Continuation of International Patent Application No. PCT/JP2024/019969, filed May 31, 2024, which claims the benefit of Japanese Patent Application No. 2023-093354, filed Jun. 6, 2023, both of which are hereby incorporated by reference herein in their entirety.

### BACKGROUND

### Field of the Technology

The present disclosure relates to communication devices that perform wireless communication.

### Description of the Related Art

The IEEE (Institute of Electrical and Electronics Engineers) 802.11 standard is known as a communication standard related to wireless LAN (wireless local area network). In this IEEE 802.11 standard, communication can be performed in frequency bands such as the 2.4 GHz band, 5 GHz band, and 6 GHz band.

U.S. Patent Application Publication 2020/0068486 describes a mechanism for utilizing a specific set of non-unitary and non-contiguous channels as channels recommended for scanning among 6 GHz channels. A scanning technique according to U.S. Patent Application Publication 2020/0068486 involves intentionally narrowing down the channels recommended for scanning to enable a shorter scanning time even in a wide band.

In IEEE 802.11ax, the concept of PSC is introduced in which a specific set of channels among multiple channels in the 6 GHz band is treated as channels recommended for scanning for the purpose of reducing the scanning time. In PSC (preferred scanning channels), a PSC serving as a channel recommended for scanning is provided for every 80 MHz.

In an access point device, it is conceivable that an operating channel of a network can be designated via, for example, a setting screen, and that an access point operates on the designated channel. If the setting screen displayed simply has a 6 GHz channel as a selection candidate, an end user not aware of the existence of the concept of PSC or the like may designate a non-PSC channel as a channel recommended for scanning. As a result, the access point operating on the operating channel set by the user may possibly become difficult to find by a station device serving as a counterpart device.

### SUMMARY

The present disclosure is directed to a mechanism for performing display control such that a channel recommended for scanning is designated via a setting screen used for designating an operating channel in, for example, the 6 GHz band.

A communication device as an aspect of the present disclosure is a communication device functioning as an access point and including a providing unit for providing, to a user, a setting screen usable for designating an operation setting of an operating channel of the access point in a specific frequency band. The setting screen provided by the providing unit is configured such that a channel that is in the specific frequency band and that is different from a channel recommended for scanning via the setting screen is not selectable as the operation setting of the operating channel of the access point in the specific frequency band, and is configured such that the channel that is recommended for scanning and that is in the specific frequency band is selectable. The channel recommended for scanning is a channel constituting PSC (preferred scanning channels) prescribed in an IEEE 802.11 standard series.

Features of the present disclosure will become apparent from the following description of embodiments with reference to the attached drawings.

### BRIEF DESCRIPTION OF THE DRAWINGS

FIG. 1 is a diagram illustrating a configuration example of a network.

FIG. 2 is a diagram illustrating an example of a hardware configuration of an AP 101.

FIG. 3 is a diagram illustrating an example of a functional configuration of the AP 101.

FIG. 4 is a flowchart illustrating an example of a process for determining an operating channel by the AP 101 according to the present disclosure.

FIG. 5 illustrates an example of a setting screen provided by the AP 101.

FIG. 6 illustrates an example of a setting screen provided by the AP 101.

FIG. 7 illustrates an example of a setting screen provided by the AP 101.

FIG. 8 illustrates an example of a setting screen provided by the AP 101.

FIG. 9 illustrates an example of a setting screen provided by the AP 101.

FIG. 10 illustrates an example of a setting screen provided by the AP 101.

FIG. 11 illustrates an example of a setting screen provided by the AP 101.

FIG. 12 illustrates an example of a setting screen provided by the AP 101.

FIG. 13 illustrates an example of the setting screen provided by the AP 101.

### DESCRIPTION OF THE EMBODIMENTS

Embodiments will now be described in detail below with reference to the appended drawings. The following embodiments are not intended to limit the present disclosure according to the claims. Although the embodiments indicate multiple features, not all of these multiple features are necessarily essential for the present disclosure, and the multiple features may be arbitrarily combined. Moreover, in the appended drawings, identical or similar components are given the same reference signs, and redundant descriptions thereof are omitted.

### Configuration of Communication System

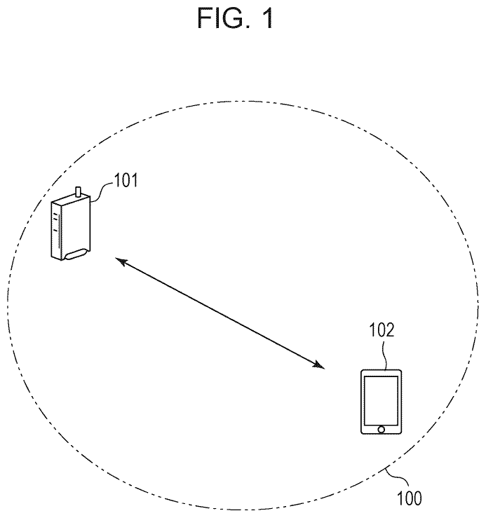

FIG. 1 illustrates the configuration of a network in which a communication device 102 (referred to as “STA 102” hereinafter) according to this embodiment participates. The STA 102 is a station (STA) having the role of participating in a network 100. A communication device 101 (referred to as “AP 101” hereinafter) is an access point (AP) having the role of establishing the network 100 that is wireless. The AP 101 is communicable with the STA 102. In other words, the AP 101 is an access point device that functions as an access point. The STA 102 is a station device that functions as a station.

Each of the AP 101 and the STA 102 can execute wireless communication compliant with the IEEE 802.11ax/be/bn standard. IEEE is an abbreviation for “Institute of Electrical and Electronics Engineers”. The AP 101 and the STA 102 can communicate in 2.4 GHz, 5 GHZ, and 6 GHz frequency bands. The frequency bands used by each communication device are not limited to the above and may be a different frequency band, such as a 60 GHz band. Moreover, the AP 101 and the STA 102 can communicate using 20 MHz, 40 MHz, 80 MHz, 160 MHz, and 320 MHz bandwidths. The bandwidths used by each communication device are not limited to the above and may be a different bandwidth, such as 240 MHz or 4 MHz.

A specific example of the AP 101 is a wireless LAN router or a personal computer (PC), but is not limited thereto. Examples include a printing device, a digital camera, and a projector each operating as a software access point or a mobile access point. A specific example of the STA 102 is a digital still camera, a tablet, a smartphone, a PC, a mobile phone, a video camera, or a headset, but is not limited thereto. The STA 102 may be an information processing device, such as a wireless chip, capable of executing wireless communication compliant with the IEEE 802.11ax/be/bn standard. Each communication device can communicate by using 20 MHz, 40 MHz, 80 MHz, 160 MHz, and 320 MHz bandwidths.

### Configuration of AP

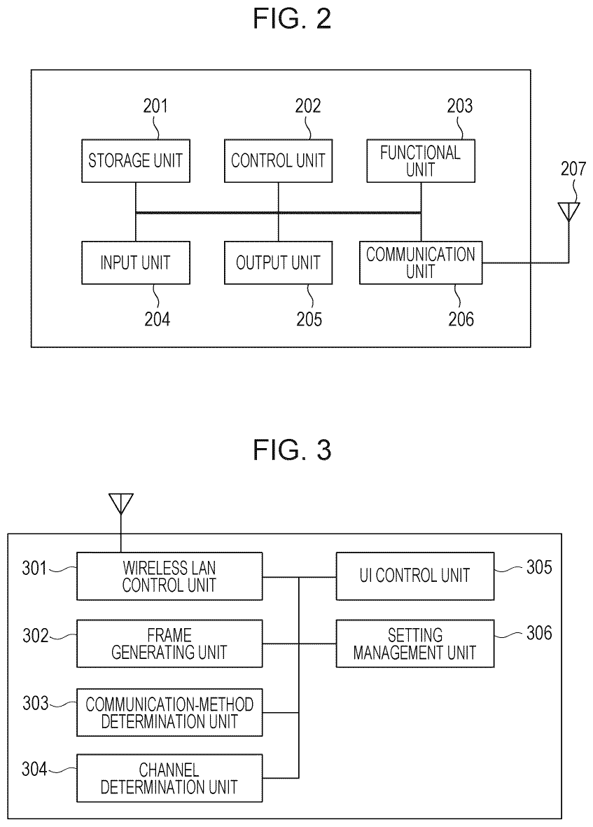

FIG. 2 illustrates a hardware configuration example of the AP 101 according to this embodiment. The AP 101 has a storage unit 201, a control unit 202, a functional unit 203, an input unit 204, an output unit 205, a communication unit 206, and an antenna 207. Multiple antennas may be provided.

The storage unit 201 is constituted of at least one memory, such as a ROM and a RAM, and a nonvolatile storage unit, and stores a computer program for performing various kinds of operation to be described later, as well as various kinds of information, such as a communication parameter, for wireless communication. ROM is an abbreviation for “read only memory”, and RAM is an abbreviation for “random access memory”. The nonvolatile storage unit is a storage unit such as a hard disk, a nonvolatile memory card, or an SSD (solid state drive).

The control unit 202 is constituted of, for example, at least one processor, such as a CPU or an MPU, and executes the computer program stored in the storage unit 201 to control the entire AP 101. The control unit 202 may control the entire AP 101 in accordance with cooperation between the computer program stored in the storage unit 201 and an OS (operating system). The control unit 202 generates data and a signal (wireless frame) to be transmitted in communication with another communication device. CPU is an abbreviation for “central processing unit”, and MPU is an abbreviation for “micro processing unit”. The control unit 202 may include multiple processors, such as multicore processors, and may control the entire AP 101 by means of the multiple processors.

The control unit 202 controls the functional unit 203 to execute a predetermined process, such as wireless communication, imaging, printing, or projection. The functional unit 203 is hardware for executing a predetermined process by the AP 101. For example, if the communication device is a camera, such as a digital still camera, or a smartphone having a camera, the functional unit 203 is an imaging unit that performs an imaging process of a surrounding image via a camera unit (not illustrated) included in the AP 101. If the AP 101 is, for example, a printer, the functional unit 203 is a printing unit that performs a printing process onto a sheet, such as paper, based on print data obtained as a result of wireless communication with an external source. The printing method may be an inkjet method involving discharging ink onto a sheet, or may be an electrophotographic method involving transferring a colorant, such as toner, onto a sheet. If the AP 101 is, for example, a projector, the functional unit 203 is a projector unit that projects image data or video data obtained as a result of wireless communication with an external source. Data to be processed by the functional unit 203 may be data stored in the storage unit 201 or may be data obtained as a result of communication with another AP or STA via the communication unit 206, to be described later.

The input unit 204 receives various operations from a user. The output unit 205 performs various kinds of output to the user via a monitor screen or a loudspeaker. The output from the output unit 205 may include display on the monitor screen, audio output from the loudspeaker, and vibration output. The input unit 204 and the output unit 205 may both be realized as a single module, as in a touchscreen. The input unit 204 and the output unit 205 may each be integrated with the AP 101, or may be an input unit and an output unit as separate units connected to the AP 101.

The communication unit 206 performs control of wireless communication compliant with the IEEE 802.11ax/be/bn standard. The communication unit 206 may perform control of wireless communication compliant with another IEEE 802.11 series in addition to the IEEE 802.11ax/be/bn standard, or may perform control of wired communication using, for example, a wired LAN. The communication unit 206 controls the antenna 207 to transmit and receive a wireless communication signal generated by the control unit 202.

If the AP 101 is compliant with the NFC standard, the Bluetooth standard, and the like in addition to the IEEE 802.11ax/be/bn standard, the AP 101 may perform control of wireless communication compliant with these communication standards. If the AP 101 can execute wireless communication compliant with multiple communication standards, the AP 101 may have an individual communication unit and antenna that correspond to each communication standard. The AP 101 exchanges data, such as image data, document data, and video data, with the STA 102 via the communication unit 206. The antenna 207 may be configured separately from the communication unit 206, or may be configured as a single module together with the communication unit 206.

The antenna 207 is an antenna capable of communicating in 2.4 GHz, 5 GHZ, and 6 GHz bands. In this embodiment, the AP 101 has a single antenna but may have three antennas. Alternatively, the AP 101 may have different antennas for the respective frequency bands. If the AP 101 has multiple antennas, the AP 101 may have the communication unit 206 corresponding to each antenna. The STA 102 has a hardware configuration similar to that of the AP 101.

In IEEE 802.11ax, the concept of PSC is introduced in which a specific set of channels among multiple channels in the 6 GHz band is treated as channels recommended for scanning for the purpose of reducing the scanning time. PSC is an abbreviation for “preferred scanning channels”. In PSC, a PSC serving as a channel recommended for scanning is provided for every 80 MHz. In detail, channels 5, 21, 37, 53, 69, 85, 101, 117, 133, 149, 165, 181, 197, 213, and 229 in the 6 GHz band are prescribed as channels constituting the PSC. In other words, the channels constituting the PSC are channels recommended for scanning prescribed in the IEEE 802.11 standard.

In this embodiment, an operating channel of a network can be designated via, for example, a setting screen in the access point device, and a function for causing an access point to operate on the designated channel is provided to the user. In this case, if the setting screen displayed simply has a 6 GHz channel as a candidate, an end user not aware of the existence of the concept of PSC or the like may designate a non-PSC channel as a channel recommended for scanning. As a result, the operating channel set by the user may possibly become difficult to find by the station device serving as a counterpart device.

In view of this, this embodiment provides a mechanism for performing display control such that a PSC channel as a channel recommended for scanning is designated via the setting screen used for designating an operating channel in, for example, the 6 GHz band.

A functional configuration of the AP 101 will now be described with reference to FIG. 3. FIG. 3 is a block diagram of the functional configuration of the AP 101 according to this embodiment. The STA 102 has a similar configuration. It is assumed here that the AP 101 includes a wireless LAN control unit 301. The number of wireless LAN control units is not limited to one, and may be two, or may be three or more. The AP 101 further has a frame generating unit 302, a communication-method determination unit 303, a channel determination unit 304, a UI control unit 305, and a setting management unit 306.

The wireless LAN control unit 301 includes an antenna and circuit for exchanging a wireless signal with another wireless LAN device, as well as a program for controlling the antenna and the circuit. In accordance with the IEEE 802.11 series, the wireless LAN control unit 301 executes wireless-LAN communication control based on a frame generated by the frame generating unit 302.

The frame generating unit 302 generates a wireless control frame to be transmitted by the wireless LAN control unit 301. The content of wireless control to be generated by the frame generating unit 302 may be limited based on operation settings managed by the setting management unit 306. Information about the generated frame is sent to the wireless LAN control unit 301 so as to be transmitted to a communication partner.

The channel determination unit 304 determines a channel that causes the AP 101 to operate based on the operation settings managed by the setting management unit, to be described later. The wireless LAN control unit 301 operates in cooperation with each unit to cause the access point to function on the determined channel.

The communication-method determination unit 303 determines a communication method, such as a communication parameter, based on, for example, a frame format received by the wireless LAN control unit 301 and supported by the counterpart device and the operation settings managed by the setting management unit 306. After the communication method is determined, the wireless LAN control unit 301 communicates with the counterpart device in accordance with the determined communication method.

The UI control unit 305 is a control unit for detecting an input from the input unit 204 and for controlling an output to the output unit 205 so as to accept a user operation, such as a setting change performed on the AP 101 by the user. The UI control unit 305 also has, for example, a function for displaying a setting screen or an image, or a function for providing information about audio output to the user. The UI control unit 305 is an example of a providing unit for providing the setting screen to the user.

The setting management unit 306 manages the operation settings of the AP 101 stored in the storage unit 201. When the UI control unit 305 detects a user operation for a setting change, the UI control unit 305 makes a request for the setting change to the setting management unit 306. The setting management unit 306 that has received the request for the setting change changes the operation settings of the AP based on the request for the setting change. Refer to a flowchart, to be described later, for the operation settings managed by the setting management unit 306, where appropriate. The setting management unit 306 manages information for identifying channels constituting the PSC and/or information for identifying channels not constituting the PSC. In this embodiment, the information for identifying channels constituting the PSC is assumed to be information containing a list of channels constituting the PSC, such as “5, 21, 37, 53, 69, 85, 101, 117, 133, 149, 165, 181, 197, 213, and 229”. In this embodiment, the information for identifying channels not constituting the PSC is assumed to be information containing a list of channels excluded from the channels constituting the PSC among the channels constituting the 6 GHz band. However, the configuration is not limited to the above.

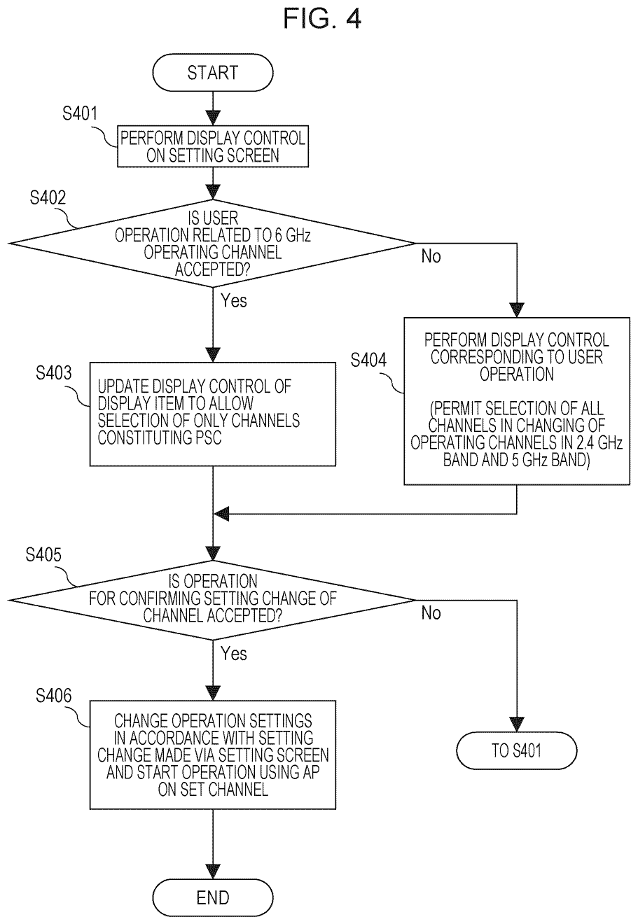

Next, setting change control in the AP 101 will be described with reference to FIG. 4. FIG. 4 is a flowchart illustrating an example of control executed by the AP 101, and is a flowchart from which a part of a setting-related process is extracted to explain setting-related control. In more detail, the flowchart in FIG. 4 illustrates a sequential process that commences when the AP 101 accepts a network-setting change operation.

The steps illustrated in the flowchart in FIG. 4 are executed when the processor of the control unit 202 of the AP 101 executes the computer program stored in the storage unit 201. Some of the steps, such as transmission and modulation, are implemented by the processor of the control unit 202 operating in cooperation with, for example, various processors, ASIC, DSP, or FGPA constituting the communication unit 206. Display control and user-operation acceptance control are implemented by the processor of the control unit 202 operating in cooperation with the input unit 204 and the output unit 205. When the entity that performs a process is to be clearly indicated, the functional unit described in FIG. 3 is used as the subject in the description.

In step S401, the UI control unit 305 of the AP 101 operates in cooperation with the output unit 205 to display a setting screen related to wireless communication to the output unit 205, so as to provide the setting screen to the user.

Then, in step S402, the UI control unit 305 operates in cooperation with the input unit 204 to determine whether a user operation related to a 6 GHz operating channel is accepted via the setting screen being provided. The process proceeds to step S403 if a user operation related to a 6 GHz operating channel is accepted via the setting screen being provided, or the process proceeds to step S404 if a user operation related to a 6 GHz operating channel is not accepted via the setting screen being provided.

In step S403, the UI control unit 305 operates in cooperation with the output unit 205 to update the display control of display items constituting the setting screen so that only the channels constituting the PSC can be selected. This control will be described later with reference to a schematic view of the setting screen.

In step S404, the UI control unit 305 operates in cooperation with the input unit 204 and the output unit 205 to perform display control corresponding to the user operation. In an operation for changing operating channels in the 2.4 GHz and 5 GHz bands, selection of all channels constituting each band is permitted. Specifically, in the 2.4 GHz band or the 5 GHz band, display control of the setting screen is performed such that a setting change operation to a channel different from a channel number constituting the PSC can be accepted.

Subsequently, in step S405, the UI control unit 305 operates in cooperation with the input unit 204 to determine whether a user operation for confirming a channel setting change is accepted. The process proceeds to step S406 if it is determined that a user operation for confirming a channel setting change is accepted, or the process proceeds to step S401 if it is determined that a user operation for confirming a channel setting change is not accepted.

Finally, in step S406, the UI control unit 305 operates in cooperation with the setting management unit 306 and the storage unit 201 to change the operation settings of the operating channels stored in the storage unit 201 in accordance with the setting change made via the setting screen. Then, the channel determination unit 304 refers to the operation settings of the operating channels stored in the storage unit 201 to determine the channel on which the AP 101 is to provide the network. Then, the wireless LAN control unit 301 operates in cooperation with the channel determination unit 304, the communication-method determination unit 303, the communication unit 206, and the antenna 207 to start an operation using the access point on the channel after the change in the operation settings. After the operation settings are changed, the AP 101 may reactivate itself and read the changed operation settings in the activation process, so as to change the operation parameters as an access point.

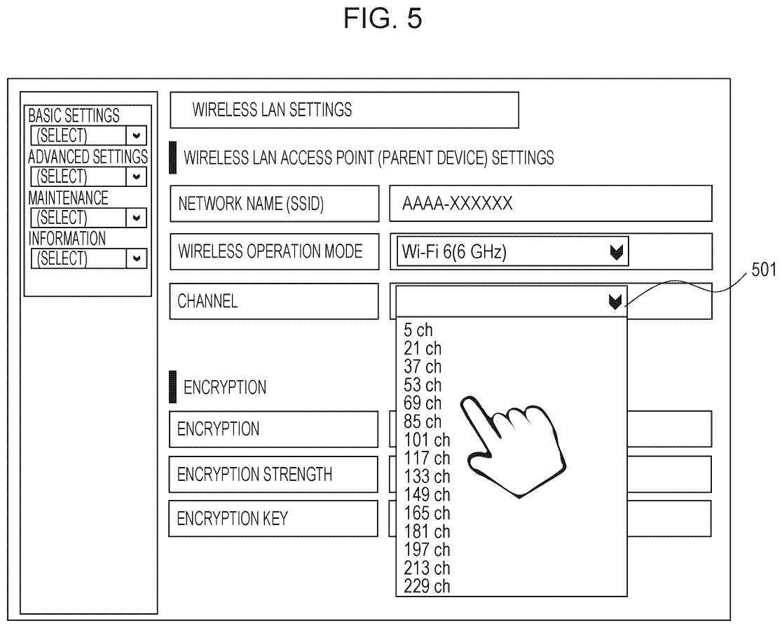

Next, the setting screen displayed in this embodiment will be described with reference to FIG. 5. FIG. 5 illustrates an example of the setting screen provided to the user by the AP 101. The user can perform a change operation for each operation setting by selecting the corresponding display item displayed on the screen in FIG. 5. FIG. 5 illustrates an example of the setting screen when 6 GHz is selected as a wireless operation mode. A display item 501 is a pulldown-list-type display item and has two kinds of display modes. The first display mode is a display mode for presenting a currently-selected channel to the user while accepting a change operation to the second display mode. When the UI control unit 305 detects that a selection operation is performed on a display region of the display item 501 displayed in the first display mode, the UI control unit 305 performs display control such that the display mode of the display item is changed to the second display mode. The selection operation performed on the display region of the display item 501 displayed in the first display mode is an example of a predetermined user operation. FIG. 5 illustrates an example of the setting screen when the display item 501 displayed in the second display mode is being displayed.

In this case, as illustrated in FIG. 5, the UI control unit 305 displays only the channels constituting the PSC as options on the pulldown list, such that only the channels constituting the PSC are selectable. Specifically, control is performed such that “5, 21, 37, 53, 69, 85, 101, 117, 133, 149, 165, 181, 197, 213, and 229” as the channels constituting the PSC are displayed as the options, whereas the channels not constituting the PSC are not displayed. In this control, the UI control unit 305 identifies the options to be displayed based on the information for identifying the channels constituting the PSC and the information for identifying the channels not constituting the PSC, which are managed by the setting management unit 306.

Then, when the UI control unit 305 operates in cooperation with the input unit 204 to detect that an operation for selecting one option from the multiple options is performed, the UI control unit 305 determines that an operation for confirming a setting change is accepted, and performs the setting change described in step S406. In this case, the UI control unit 305 operates in cooperation with the output unit 205 to update the display mode of the display item 501 to the first display mode. For example, when an operation for selecting an option “69 ch” is performed, the display mode of the display item 501 on the setting screen is updated to the first display mode for presenting a text string “69 ch” corresponding to the relevant option to the user.

This embodiment describes a pulldown list as an example of a display item for selection, but is not limited thereto. The display item may be such that one option from multiple options can be selected, where appropriate. For example, multiple options may be listed, and a radio button that enables selection of one option alone is possible.

By performing control for providing the setting screen described above, when the operation setting of an operating channel in the 6 GHz band is to be performed via the setting screen, display control can be performed such that a non-PSC operating channel is prevented from being selected. Accordingly, operating channels selectable by a user operation are the channels constituting the PSC alone, so that the access point can operate on any of the channels constituting the PSC in the case of 6 GHz.

### Modification 1

The above embodiment corresponds to an example of providing the setting screen that allows selection of only the channels constituting the PSC by displaying only the channels constituting the PSC as options. Alternatively, the setting screen provided may be configured to present information about a channel not constituting the PSC to the user but not to allow selection thereof.

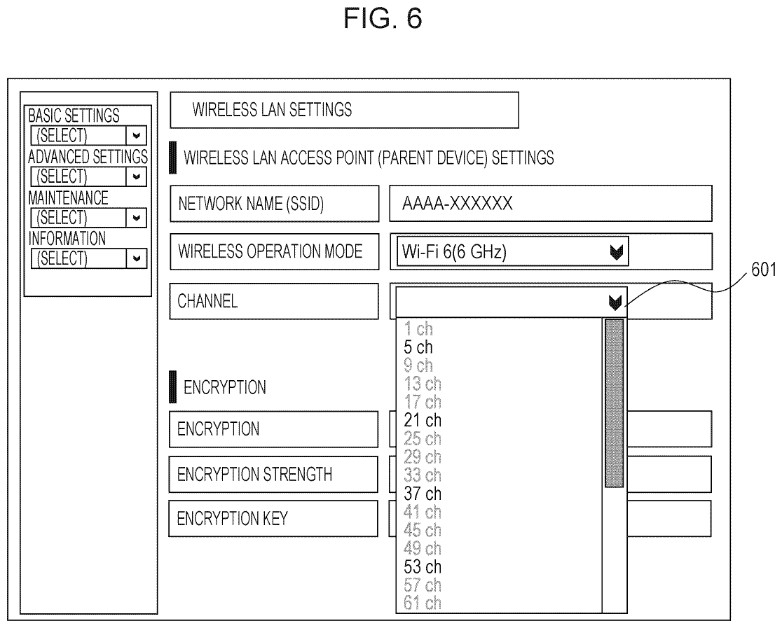

A detailed description will be provided with reference to FIG. 6. FIG. 6 illustrates an example of a setting screen provided to the user by the AP 101 in place of the setting screen in FIG. 5 in the above embodiment. The difference from the setting screen in FIG. 5 is that a display item 601 is displayed in place of the display item 501.

The UI control unit 305 displays information about a channel not constituting the PSC as an option, but displays it in a grayed-out state. Even when a selection operation by the user is detected on the option in the grayed-out state, control is performed so as to not confirm the selection operation. In this control, the UI control unit 305 identifies options to be displayed in the grayed-out state or the normal state based on the information for identifying the channels constituting the PSC and/or the information for identifying the channels not constituting the PSC, which are managed by the setting management unit 306.

### Modification 2

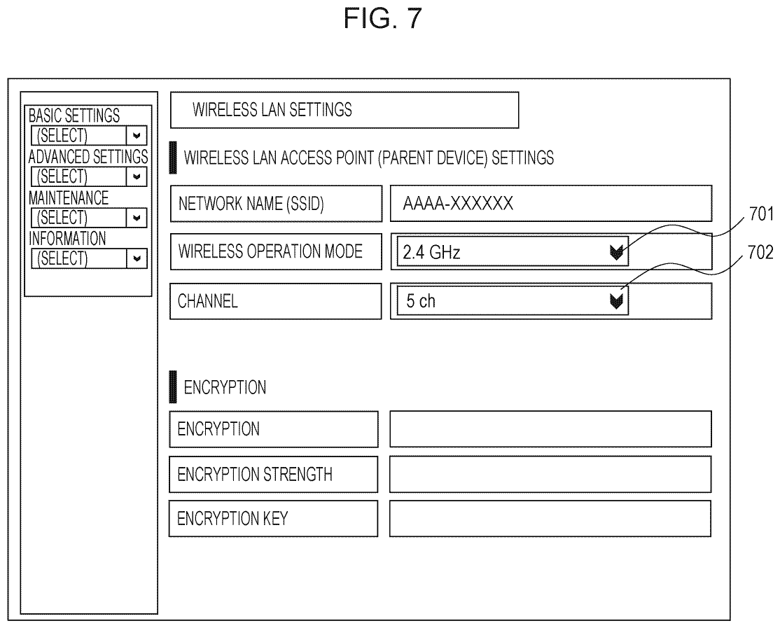

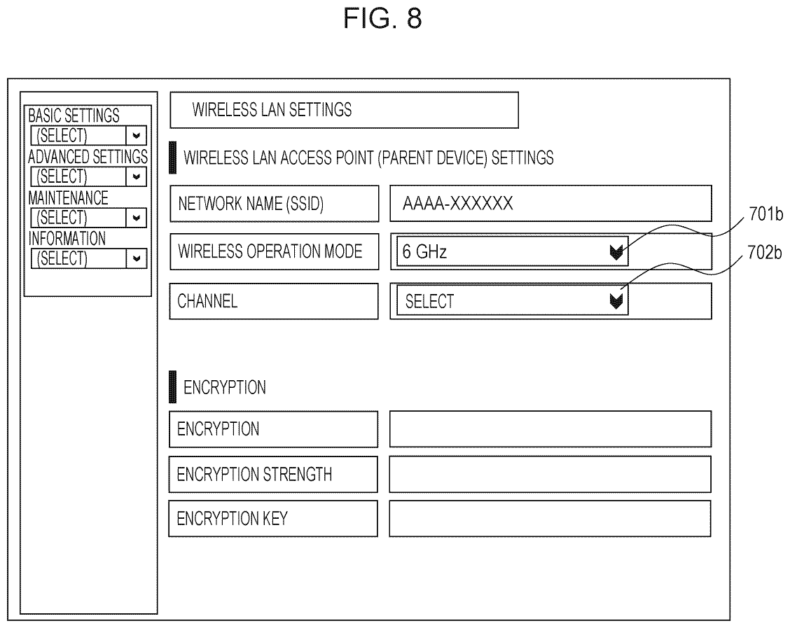

The following prohibition control may further be performed on the setting screens described in FIG. 5 and FIG. 6. FIG. 7 and FIG. 8 each illustrate an example of a setting screen on which prohibition control is performed and that is provided to the user by the AP 101. When a user operation is performed for the operation settings in the 6 GHz band via a display item 701 in a state where the setting screen used for the operation settings in the 2.4 GHz is displayed, the UI control unit 305 updates the display of a display item 702 to an unselected state. A display item 701b in FIG. 8 is an example of a display item after the display of the display item 701 is updated, and a display item 702b is an example of a display item after the display of the display item 702 is updated.

If a channel selected as an operating channel in another frequency band has the same channel number as a channel constituting the PSC in the 6 GHz band, the UI control unit 305 may perform control so as not to perform the prohibition control. For example, if an operation for the operation settings in the 6 GHz band is accepted in a state where channel 5 in the 2.4 GHz band or channel 165 in the 5 GHz band is selected, the UI control unit 305 may perform display control on the setting screen so as to maintain the selected state of channel 5 or channel 165. On the other hand, if an operation for the operation settings in the 6 GHz band is accepted in a state where channel 1 in the 2.4 GHz band or channel 157 in the 5 GHz band is selected, the UI control unit 305 updates the display item for setting the operating channel to an unselected channel state. In the case where the aforementioned prohibition control is to be performed, an update to a state where an auto mode for automatically selecting a channel may be performed instead of an update to the unselected channel state. If this auto mode is selected via the setting screen and the operation settings of the storage unit 201 are updated, the channel determination unit 304 performs control for automatically selecting a non-congested channel from among the channels constituting the PSC.

### Modification 3

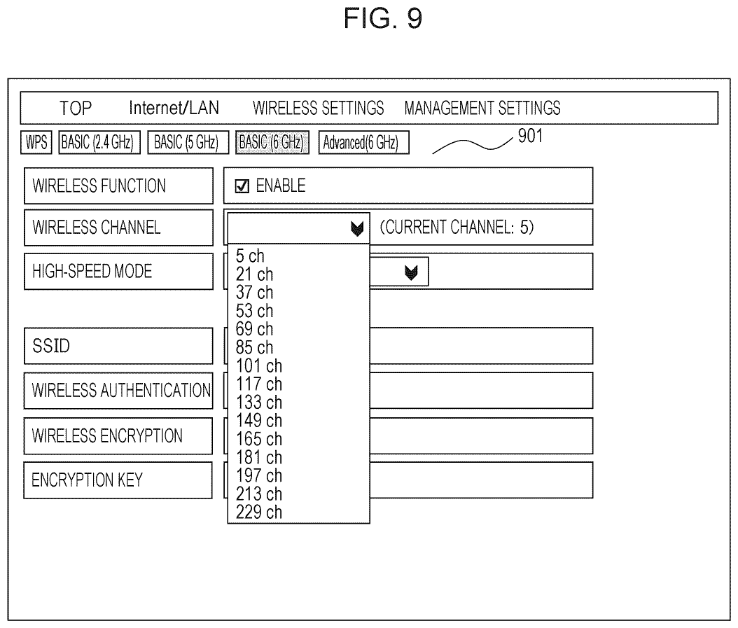

The setting screen may be modified to provide a different setting screen for every band. FIG. 9 illustrates an example of a setting screen that is provided by the AP 101 and that is a basic setting screen for the 6 GHz band. Display items located in the upper area for WPS, basic (2.4 GHz), basic (5 GHZ), basic (6 GHZ), and advanced (6 GHz) are display items to be used for switching the setting screen. Modification 3 and Modification 1 may be combined, where appropriate.

### Modification 4

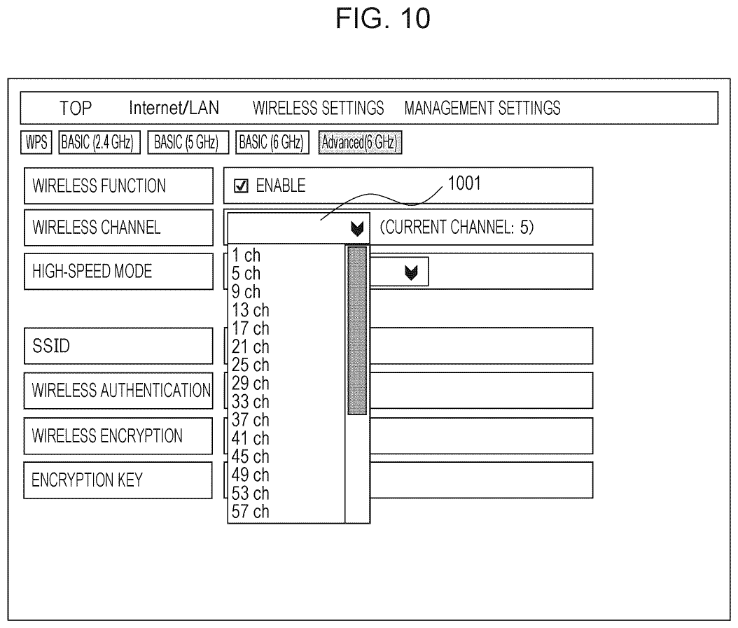

In addition to Modification 3, a channel not constituting the PSC may be selectable via a setting screen for an advanced setting mode. By selecting a display item 901 in FIG. 9, the display can be switched to the setting screen for the advanced setting mode. When the UI control unit 305 detects an operation for selecting the display item 901, the UI control unit 305 switches the setting screen displayed in the output unit 205 to the setting screen for the advanced setting mode illustrated in FIG. 10. FIG. 10 illustrates an example of the setting screen that is provided by the AP 101 and that is a screen for the advanced setting mode for the 6 GHz band. This setting screen for the advanced setting mode is an example of a second setting screen.

Upon detecting an operation for selecting a display item 1001 in the first display mode, the UI control unit 305 displays the display item 1001 in the second display mode. FIG. 10 illustrates an example where a drop-down-list display item is displayed in the second display mode. The display item 1001 in the second display mode displays multiple options, similarly to that in the above embodiment.

However, the difference is that a channel not constituting the PSC, which is not selectable in each embodiment, is also selectable. With this setting screen for the advanced setting mode, a more customizable setting mode can be provided to a user knowledgeable in network technology.

This modification relates to an example where an advanced setting screen is provided to the user based on a method of transitioning the display screen from another setting screen, such as a basic setting screen, to a setting screen for an advanced setting mode, but is not limited thereto. A checkbox or pulldown menu for, for example, “advanced settings” may be provided, and if an operation for the advanced settings via the checkbox or the pulldown menu is detected, the display of the setting screen may be dynamically updated. In a case where a checkbox is used, when the UI control unit 305 detects an operation for checking the checkbox related to the advanced setting mode, the UI control unit 305 updates the display of the setting screen to allow selection of all channels in the 6 GHz band. In a case where a pulldown menu is used, when the UI control unit 305 detects a selection operation to the advanced setting mode via the pulldown menu, the UI control unit 305 dynamically updates the display of the setting screen to newly display a display item used for selecting a channel for the advanced setting mode.

### Modification 5

The screen configuration may be modified to provide an integrated setting screen such that the operating frequency bands of multiple networks provided by the AP 101 and the settings of the operating channels can be changed simultaneously on a single setting screen.

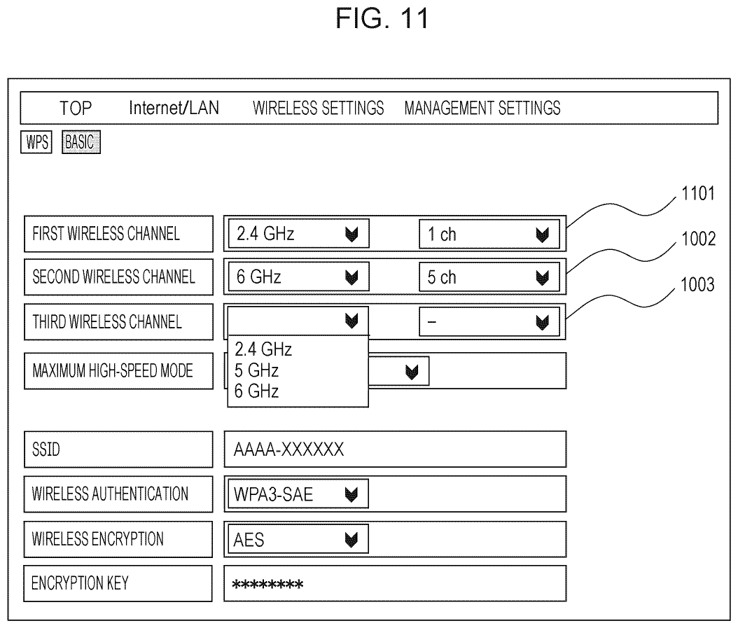

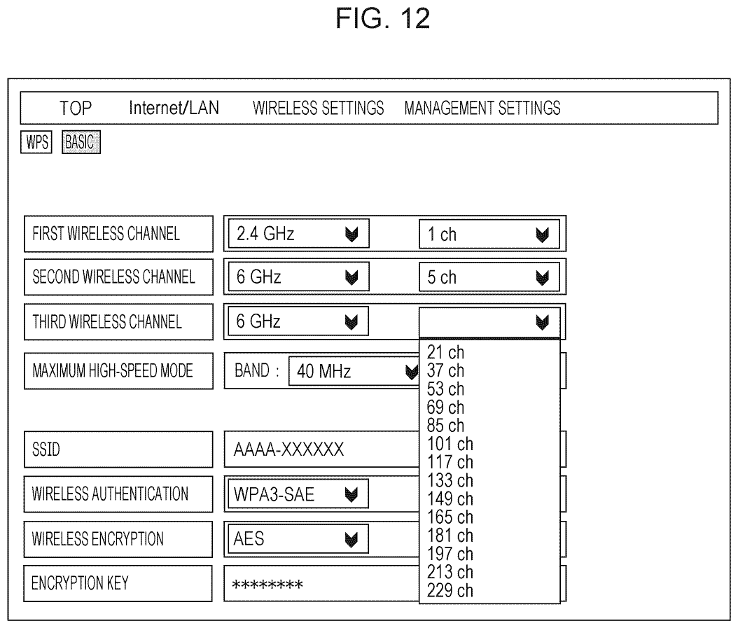

FIG. 11 and FIG. 12 each illustrate an example of the integrated setting screen provided by the AP 101. The setting screen in FIG. 11 displays sets 1101, 1002, and 1003 of display items for selecting frequency bands and display items for selecting operating channels. The setting screen in this example corresponds to a case where three different networks are provided by the AP 101.

The user uses the display item for selecting the frequency band constituting any of the sets 1101, 1002, and 1003 to perform an operation for changing the operating frequency band that provides a network. Then, the user uses the display item for selecting the corresponding channel to perform an operation for changing the operating channel. With these two operations, the settings for the operating frequency band and the operating channel that provide the network can be changed via the integrated setting screen. FIG. 12 illustrates a display example of the setting screen corresponding to a case where a change operation for the operating channel is performed after the 6 GHz band is selected. In this case, as illustrated in FIG. 12, the UI control unit 305 performs display control on the setting screen such that only a channel constituting the PSC is selected via the display item for changing the operating channel corresponding to the 6 GHz band.

If a specific channel in the 6 GHz band is already selected in another set, the specific channel may also be excluded from the options, and multiple options may be displayed.

For example, in FIG. 12, since channel 5 in the 6 GHz band is already set as a second network set in a second set, channel 5 is excluded from the options displayed in FIG. 12. Moreover, when a configuration is made to provide multiple networks in the same frequency band, a modification may be made such that further prohibition control is performed to prevent adjacent channels from being selected as networks in the same frequency band.

For example, when the channel 5 network in the 6 GHz band is set to be provided as the second network in FIG. 11, the following prohibition is further provided to the display item for selecting an operating channel in the set 1003. In detail, channel 21 adjacent to channel 5 is not included as an option, such that channel 37, channel 53, channel 69, channel 85, channel 101, channel 117, channel 133, channel 149, channel 165, channel 181, channel 197, channel 213, and channel 229 are displayed as options. The display control using the grayed-out feature described in Modification 1 is similarly applicable to Modification 5.

### Modification 6

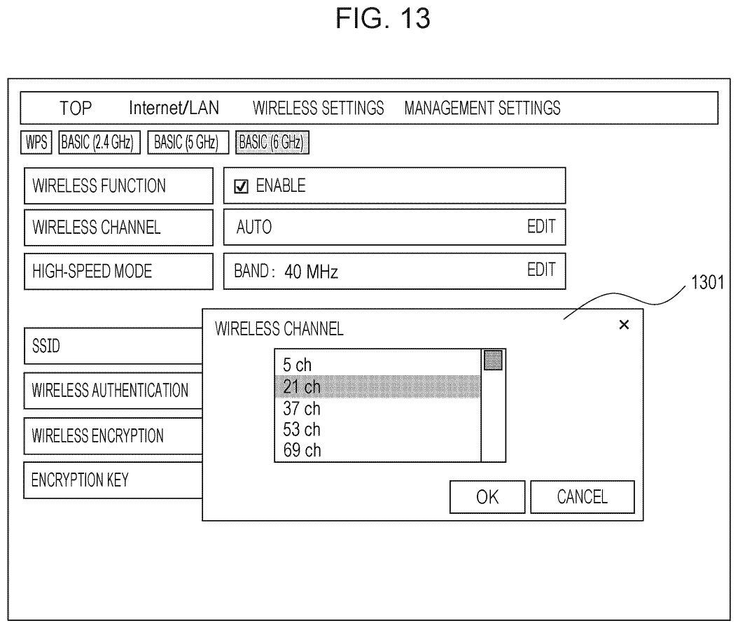

The above embodiment relates to an example of accepting a selection operation for an operating channel in the 6 GHz band by using a display item, such as a pulldown list or a radio box, but may relate to another mode. For example, when an operation for changing an operating channel in the 6 GHz band is accepted via the setting screen, a child window for a setting may be displayed in a pop-up fashion to accept a setting change. FIG. 13 illustrates an example of a setting screen provided as a child window by the AP 101. The selection method for a frequency band is similar to that in the above embodiment and the above modifications. In place of a pulldown list or a radio box, a display item including a text string indicating the current operating channel and a text string, such as “edit”, may be displayed. In this case, when the UI control unit 305 detects that an “edit” region is selected by a user operation, the UI control unit 305 performs control to display a child window 1301. The child window displays a list of multiple options indicating the channels constituting the PSC. On the list, one of the options is designatable. The UI control unit 305 updates the display of the child window based on a setting operation performed via the child window. Upon detecting that an OK key is selected as an operation for confirming the setting, the UI control unit 305 operates in cooperation with each unit to update the operation settings stored in the storage unit 201 based on the setting operation performed via the child window. The display control using the grayed-out feature described in Modification 1 is similarly applicable to Modification 6.

### Modification 7

Each of the above embodiment and Modifications 1 to 3 and 5 and 6 provides a mechanism for suppressing selection of a channel not constituting the PSC in accordance with preliminary display control, but is not limited thereto.

A modification may be made such that, when a channel not constituting the PSC is selected, an error handling process is performed, which involves performing control so as not to perform a setting change based on selection and also suppressing a setting change to the channel not constituting the PSC by displaying, for example, an error screen (not illustrated).

In this case, the UI control unit 305 determines whether an option selected by the user is an option corresponding to a channel constituting the PSC. This determination is performed based on the information for identifying the channels constituting the PSC and/or the information for identifying the channels not constituting the PSC, which are managed by the setting management unit 306, and also based on the option selected by the user.

When determining that the option selected by the user is an option not corresponding to a channel constituting the PSC, the UI control unit 305 performs the aforementioned error handling process. In contrast, if it is determined that the option selected by the user is an option corresponding to a channel constituting the PSC, a setting change process is performed. In detail, the UI control unit 305 operates in cooperation with each unit to update the operation settings stored in the storage unit 201 such that the operation setting of the operating channel in the 6 GHz band is a setting that causes an operation to be performed on the operating channel corresponding to the option selected by a user operation. In this case, a channel number may be directly input via a keyboard or a software keyboard instead of being selected from options, so that a change operation can be accepted. In this case, the UI control unit 305 may determine whether a value directly input via the keyboard or the software keyboard matches the number of the channel constituting the PSC, and may either update the operation settings or set as an error in accordance with the determination.

### Modification 8

The present disclosure is also applicable to a case where an operation for changing an operating channel in the 6 GHz band is accepted by an audio input operation or a command input operation. When determining that the change operation is an operation for changing to a channel not constituting the PSC, the UI control unit 305 performs the error handling process without accepting a setting change. On the other hand, when determining that the change operation is an operation for changing to a channel constituting the PSC, the UI control unit 305 accepts a setting change. A notification of the result of the setting change is provided by a method corresponding to the input operation. In the case of audio input operation, a notification of success or failure may be provided via a loudspeaker. In the case of command input operation, a notification may be provided by means of a text string indicating success or failure as a command execution result.

### Modification 9

In each of the above embodiments and the above modifications, a modification may be made such that only one or more of the channels constituting the PSC are settable as operating channels in the 6 GHz band. More specifically, a channel that cannot be used or should not be used based on radio regulations of a country in which the product is sold or constraints of hardware, such as a wireless chip and an antenna mounted in the product, may be prevented from being set as an operating channel in the 6 GHz band. As a result, if there is not a single channel that can be used in the 6 GHz band and that constitutes the PSC, the operation setting in the 6 GHz band may be not performable. If Modification 9 is applied to Modification 1, the UI control unit 305 identifies a group 1 of options from which the aforementioned channel that cannot be used or should not be used is excluded with respect to the channels constituting the PSC. Moreover, with respect to the channels not constituting the PSC, a group 2 of options from which the aforementioned channel that cannot be used or should not be used is excluded is identified. Subsequently, the UI control unit 305 displays options corresponding to the identified group 1 of options in a selectable manner, and displays options corresponding to the identified group 2 of options in a grayed-out state. Then, even if the UI control unit 305 detects that the user has performed a selection operation on any option from among the group 2 of options, the UI control unit 305 performs display control to prevent the corresponding channel from being selected.

### Modification 10

Although each of the above embodiments and the above modifications corresponds to an example where a setting screen is provided to the user via the output unit 205 included in the AP 101 when the setting screen is to be displayed, the method for providing the setting screen is not limited to this.

The UI control unit 305 may function as an HTTP server, and may provide a setting screen to the user by providing web content corresponding to the setting screen to the STA to which the HTTP server provides a network connection. HTTP is an abbreviation for “Hypertext Transfer Protocol”. For example, the AP 101 provides web content corresponding to each setting screen described in the above embodiment in accordance with a request (HTTP request) from a web browser application included in the connected STP. The web browser application of the STA, such as the STA 102, having received the web content displays a setting screen as a web screen based on the received web content. Moreover, the web browser application of the STA transmits, to the HTTP server, information for identifying the content of an operation input via a display item on the web screen. The transmission can be performed by using, for example, the POST method. The UI control unit 305 appropriately changes the operation settings stored in the storage unit 201 based on the information for identifying the content of the operation received from the web browser application of the STA by, for example, the POST method.

If the web-based user interface described in Modification 10 is to be provided, the STA may be provided with web content containing a script, such as JavaScript (registered trademark), for dynamically updating the setting screen, where necessary. In this case, the script serving as the web content is executed by a script engine of the web browser, so that the setting screen is dynamically updated. This script engine is realized by the processor of the STA, such as the STA 102, executing a program code for implementing the script engine.

According to an aspect of the present disclosure, display control can be performed such that a channel recommended for scanning is designated via a setting screen used for designating an operating channel in, for example, the 6 GHz band. Thus, when an operating channel is to be set by a user operation, designation of a channel different from the channel recommended for scanning can be suppressed.

### OTHER EMBODIMENTS

The present disclosure can also be realized by supplying a program that implements at least one feature of the above embodiment to a system or a device via a network or a storage medium and causing at least one processor in a computer of the system or the device to read and execute the program. Moreover, the present disclosure can also be realized by a circuit (e.g., ASIC) that implements at least one feature.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. A communication device functioning as an access point, the communication device comprising:
a providing unit configured to provide a setting screen to a user, the setting screen being usable for designating an operation setting of an operating channel of the access point in a specific frequency band,
wherein the setting screen provided by the providing unit is configured such that a channel that is in the specific frequency band and that is different from a channel recommended for scanning via the setting screen is not selectable as the operation setting of the operating channel of the access point in the specific frequency band, and is configured such that the channel that is recommended for scanning and that is in the specific frequency band is selectable, and
wherein the channel recommended for scanning is a channel constituting preferred scanning channels prescribed in an IEEE 802.11 standard series.

2. The communication device according to claim 1, wherein the specific frequency band is a 6 GHz band.

3. The communication device according to claim 2, wherein the communication device is a printing device.

4. The communication device according to claim 3, wherein display control is performed by displaying a display item on the setting screen such that the channel different from the channel constituting the preferred scanning channels is prevented from being selected, the display item being usable for selecting the operating channel and being capable of accepting a selection operation for selecting at least a portion of the channel constituting the preferred scanning channels and not accepting a selection operation for selecting a channel not constituting the preferred scanning channels.

5. The communication device according to claim 4, wherein the display item on the setting screen is a display item that displays a pulldown list and that displays a plurality of options when a predetermined user operation is performed on the pulldown list, and wherein the display control is performed such that the pulldown list displays an option included in the plurality of options and corresponding to at least a portion of the channel constituting the preferred scanning channels in a selectable manner and displays a group of options corresponding to a channel not constituting the preferred scanning channels in a grayed-out manner, and that, even if a selection operation performed by the user on any of the options in the group is detected, a corresponding channel is prevented from being selected.

6. The communication device according to claim 4, wherein the display item on the setting screen is a display item that displays a pulldown list and that displays a plurality of options when a predetermined user operation is performed on the pulldown list, and wherein the pulldown list is such that the plurality of options displayed by the pulldown list include an option corresponding to at least a portion of the channel constituting the preferred scanning channels but do not include an option corresponding to the channel not constituting the preferred scanning channels.

7. The communication device according to claim 4, further comprising a storage unit configured to store, as information related to the preferred scanning channels, information for identifying the channel constituting the preferred scanning channels and/or information for identifying the channel not constituting the preferred scanning channels,
wherein the providing unit provides the setting screen configured such that display of the display item is controlled based on at least the information related to the preferred scanning channels.

8. The communication device according to claim 1, wherein the providing unit provides a second setting screen different from the setting screen to the user when an operation different from an operation for displaying the setting screen is accepted, and
wherein the second setting screen is a screen on which the operation setting of the operating channel of the access point in the specific frequency band is designatable and that is configured to be capable of accepting selection of any one channel from among a plurality of channels in the specific frequency band, the plurality of channels including at least a portion of the channel recommended for scanning and at least a portion of the channel different from the channel recommended for scanning.

9. A communication device functioning as an access point, the communication device comprising:
a providing unit configured to provide a setting screen to a user, the setting screen being usable for designating an operation setting of an operating channel of the access point in a specific frequency band; and
a control unit configured to perform control to perform a setting change based on a user operation accepted via the setting screen in accordance with whether the user operation is for changing to a channel constituting preferred scanning channels, or to not perform the setting change based on the accepted user operation in accordance with whether the user operation is for changing to a channel not constituting the preferred scanning channels.

10. The communication device according to claim 9, wherein the providing unit provides a predetermined notification to the user in a case where the control unit performs the control to not perform the setting change.

11. The communication device according to claim 10, wherein the predetermined notification is a notification indicating an error.

12. The communication device according to claim 11, wherein the providing unit provides, to a station device communicably connected to the access point, web content constituting the setting screen in response to a request from the station device, and provides the setting screen to the user by causing the setting screen to be displayed in the station device.

13. A control method of a communication device functioning as an access point, the control method comprising:
providing a setting screen to a user, the setting screen being usable for designating an operation setting of an operating channel of the access point in a specific frequency band,
wherein the setting screen provided in the providing step is configured such that a channel different from a channel recommended for scanning is prevented from being selected as the operation setting of the operating channel of the access point in the specific frequency band.

14. A control method of a communication device functioning as an access point, the control method comprising:
providing a setting screen to a user, the setting screen being usable for designating an operation setting of an operating channel of the access point in a specific frequency band; and
performing control to perform a setting change based on a user operation accepted via the setting screen in accordance with whether the user operation is for changing to a channel constituting preferred scanning channels, or to not perform the setting change based on the accepted user operation in accordance with whether the user operation is for changing to a channel not constituting the preferred scanning channels.
